(19) United States
(12) Patent Application Publication
(10) Pub. No.: US 2010/0133908 A1
(43) Pub. Date: Jun. 3, 2010

(54) USB DEVICE WITH INTERNAL ASSISTING POWER

(75) Inventor: WEI-KUANG WENG, Hsinchu (TW)

Correspondence Address: WPAT, PC;INTELLECTUAL PROPERTY ATTORNEYS, 7225 BEVERLY ST., ANNANDALE, VA, 22003, US

(73) Assignee: LITE-ON IT CORP., Taipei City (TW)

(21) Appl. No.: 12/616,461

(22) Filed: Nov. 11, 2009

(30) Foreign Application Priority Data
Nov. 28, 2008 (CN) 200810181942.9
Jan. 23, 2009 (CN) 200910002589.8

(51) Int. Cl. H02J 7/34; H02J 1/10

(52) U.S. Cl. 307/48; 307/44

(57) ABSTRACT

An universal-serial-bus external device is connected to an universal-serial-bus port of a computer host and the universal-serial-bus port comprises a positive-power end from which a main current is outputted. The external device includes: a load circuit comprising a positive-power end to which a main current is outputted from the positive-power end of the universal-serial-bus port, wherein a load current, for driving the universal-serial-bus external device, is inputted to the positive-power end of the load circuit; and an assisting-power circuit comprising an output end from which an assisting current is outputted to the positive-power end of the load circuit; wherein the load circuit is only provided by the main current if the load current is lower than a first threshold current; and, the load circuit is provided by both the main current and the assisting current if the load current is higher than a second threshold current.

### FIELD OF THE INVENTION

The present invention relates to an USB (universal serial bus) external device, and more particularly to an USB external device with an internal assisting power.

### BACKGROUND OF THE INVENTION

FIG. 1 is a block diagram illustrating a system of an USB external device connected to a computer host via an USB port. The system comprises a computer host 10 and an USB external device 12. The computer host 10 further comprises an USB port 102. In the standard interface of USB, there are four terminals including a positive-data terminal (D+), an negative-data terminal (D−), a positive-power terminal (V+), and a ground (GND), where the positive-data terminal (D+) and the negative-data terminal (D−) are used for the data transmitting between the computer host 10 and the USB external device 12; the positive-power terminal (V+) is used for providing powers to the USB external device 12 from the computer host 10. The positive-data terminal (D+), negative-data terminal (D−), positive-power terminal (V+), and ground (GND) of the USB external device 12 are connected to the positive-data terminal (D+), negative-data terminal (D−), positive-power terminal (V+), and ground (GND) of the USB external device 12, respectively.

In the USB specification, the voltage provided to the USB external device 12 from the computer host 10 is named as USB-port voltage (Vbus) and is about 5V; the current provided to the USB external device 12 from the computer host 10 is named as USB-port current (Thus) and is about 0.5 A. However, the actual USB-port current (Ibus) outputted from the positive-power terminal (V+) of the USB port in most computer hosts (desk-top or lap-top computer systems) may be up to 1.3 A, even 1.5 A in some special computer hosts.

Because the actual USB-port current (Ibus) outputted from the USB port 102 in most the computer systems is up to 1.3 A, the USB external device 12 is designed to work properly if the driving current is lower than the maximum USB-port current (Ibus, 1.3 A). In other words, the USB external device 12 may not work normally if the demanding USB-port current (Ibus) is higher than 1.3 A, which is out of the capability of the USB port 102. For example, when a slim optical disc drive is driving a servo motor or a tray, the current peak demanded of the slim optical disc drive may be higher than 1.3 A. Because the USB port 102 cannot provide such a higher USB-port current (Ibus, more than 1.3 A) to the slim optical disc drive (USB external device 12), the USB external device 12 may not work normally.

In the USB port 102 of the computer host 10, there is a CMOS device (not shown) functioned as a current meter and there is the resistance effect in the CMOS device. Because the resistance effect in the CMOS device, the USB-port voltage (Vbus) is inverse proportional to the USB-port current (Ibus). That is, the USB-port voltage (Vbus) may drop from 5V to an alarm value (such as 4.6V) if the USB-port current (Ibus) is higher than 1.3 A. Once the USB-port voltage (Vbus) is dropped to the alarm value (4.6V), the computer host 10 may shut-down the USB port 102 forcedly, accordingly the USB external device 12 fails to work normally. To deal with the problem that the USB port 102 cannot guarantee to stably provide the USB-port voltage (Vbus, higher than 4.6V) to the USB external device 12 if the current demanded by the USB external device 12 is higher than 1.3 A, the USB external device 12 can be powered via a external power adapter 14 as depicted in FIG. 1. Via the power adapter 14 connected to a plug 16 to receive AC power, most of demanding current of the USB external device 12 is provided by the adapter 14 so as the USB-port current (Ibus) can be lower than 1.3 A and the USB-port voltage (Vbus) can be maintained higher than the alarm value (4.6V), and accordingly the function of the USB external device 12 is guaranteed. However, most of user may not like the inconvenient and complicate way to power the USB external device 12 via the adopter 14.

Besides, according to USB specification, more than one USB external devices (up to 127 USB external devices) can be plugged to an USB port via a hub at the same time. However, the USB-port current (Ibus) capable outputted from the USB port is always limited at 1.3 A, the shut-down of the USB port may be happened. To deal with the problem, a hub can supply power actively is disclosed in U.S. Pat. No. 7,017,055. FIG. 2 is a block diagram illustrating a hub which can supply power actively as disclosed in U.S. Pat. No. 7,017,055. The hub comprises a battery charger 21, a storage battery 23, a DC/DC converter 25, a control circuit 27, and a circuit of a hub 29. The battery charger 21 is connected to an USB port of a computer host (not shown) from which an USB-port voltage (Vbus, 5V) and an USB-port current (Ibus, 0.5 A) are outputted. Moreover, the battery charger 21 is also connected to a power adapter. The storage battery 23 is connected to an output end of the battery charger 21. An input end of the DC/DC converter 25 is connected to an output end of the storage battery 23, and an output end of the DC/DC converter 25 is connected to both of the USB port of the computer host and the circuit of a hub 29. An input end of the control circuit 27 is connected to the storage battery 23; a first output end of the control circuit 27 is connected to the DC/DC converter 25; and a second output end of the control circuit 27 is connected to the battery charger 21. A first control signal (CS-1) is outputted to the DC/DC converter 25 from the first output end of the control circuit 27 according to the demanding power of the circuit of a hub 29; also, a second control signal (CS-2) is outputted to the battery charger 21 from the second output end of the control circuit 27 according to the demanding power of the circuit of a hub 29.

According to the disclosure of U.S. Pat. No. 7,017,055, the first control signal (CS-1) for turning off the DC/DC converter 25 and the second control signal (CS-2) for turning on the battery charger 21 are outputted from the control circuit 27 if the power demanded of the circuit of a hub 29 is less than the power (5V/0.5 A) provided by the USB port of the computer host. Because the USB port can supply the power demanded of the circuit of a hub 29, the DC/DC converter 25 is OFF and the battery charger 21 is ON. At the meanwhile, the power (5V/0.5 A) provided by the USB port can also be used for charging the storage battery 23 (battery charger 21 is ON).

On the other hand, the first control signal (CS-1) for turning on the DC/DC converter 25 and the second control signal (CS-2) for turning off the battery charger 21 are outputted from the control circuit 27 if the power demanded of the circuit of a hub 29 is higher than the power (5V/0.5 A) capable provided by the USB port of the computer host. Because the DC/DC converter 25 is ON and the battery charger 21 is OFF, all the power demanded of the circuit of a hub 29 is provided by the storage battery 23. That is, the power stored in the storage battery 23 can be provided to the circuit of a hub 29 via the DC/DC converter 25 if the power demanded of the circuit of a hub 29 is higher than the power (5V/0.5 A) capable provided by the USB port of the computer host.

However, because the turn on or the turn off the battery charger 21 and the DC/DC converter 25, or, power the circuit of a hub 29 via the storage battery 23 or via the USB port, is controlled by the control circuit 27, the design of the control circuit 27 is accordingly complicate. Moreover, when the power demanded of the circuit of a hub 29 is higher than the power (5V/0.5 A), all the power demanded of the circuit of a hub 29 is provided by the storage battery 23, that is, the power (5V/0.5 A) provided by the USB port is not used. Moreover, because the storage battery 23 is responsible for providing all the power to the circuit of a hub 29 when the power demanded of the circuit of a hub 29 is higher than (5V/0.5 A), the storage battery 23 must be implemented by several batteries coupled in series, so as the size of the storage battery 23 is relative large.

### SUMMARY OF THE INVENTION

Therefore, the present invention relates to an USB external device with an internal assisting power for solving the problems described above.

The present invention provides an universal-serial-bus external device connected to an universal-serial-bus port of a computer host, wherein the universal-serial-bus port comprises a positive-power end from which a main current is outputted, comprising:
a load circuit comprising a positive-power end, wherein a load current, for driving the universal-serial-bus external device, is inputted to the positive-power end of the load circuit; and
an assisting-power circuit comprising an output end from which an assisting current is outputted to the positive-power end of the load circuit;
wherein the load circuit is only provided by the main current if the load current is lower than a first threshold current; and, the load circuit is provided by both the main current and the assisting current if the load current is higher than a second threshold current.

According to an embodiment of the present invention, the assisting-power circuit further comprises:
a battery charger comprising an input end connected to the positive-power end of the universal-serial-bus port and an output end connected a storage battery; and
a boost regulator, connected to the output end of the battery charger, from which the assisting current is outputted to the positive-power end of the load circuit.

According to an embodiment of the present invention, the assisting-power circuit further comprises:
a current detector comprising an input end, an output end, and a control end, wherein the load current is flowed from the input end of the current detector to the output end of the current detector;
a switch comprising an input end connected to an output end of the boost regulator, an output end connected to the input end of the current detector, and a control end connected to the control end of the current detector;
wherein the switch is controlled to ON by the current detector if the load current is up to the value of the first threshold current; and, the switch is controlled to OFF by the current detector if the load current is down to the value of the second threshold current.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a block diagram illustrating a system of an USB external device connected to a computer host via an USB port;

FIG. 2 is a block diagram illustrating a hub which can supply power actively disclosed in U.S. Pat. No. 7,017,055;

FIG. 3A is a block diagram illustrating an USB external device with an internal assisting power of the first embodiment of the present invention;

FIG. 3B is a chart illustrating the change of the related voltages and currents in the USB external device with an internal assisting power of the first embodiment of the present invention;

FIG. 4A is a block diagram illustrating an USB external device with an internal assisting power in a second embodiment of the present invention;

FIG. 4B is a chart illustrating the change of the currents and the control signal in the USB external device with an internal assisting power of the second embodiment of the present invention; and

FIG. 5 is a block diagram illustrating an USB external device with an internal assisting power of a third embodiment of the present invention.

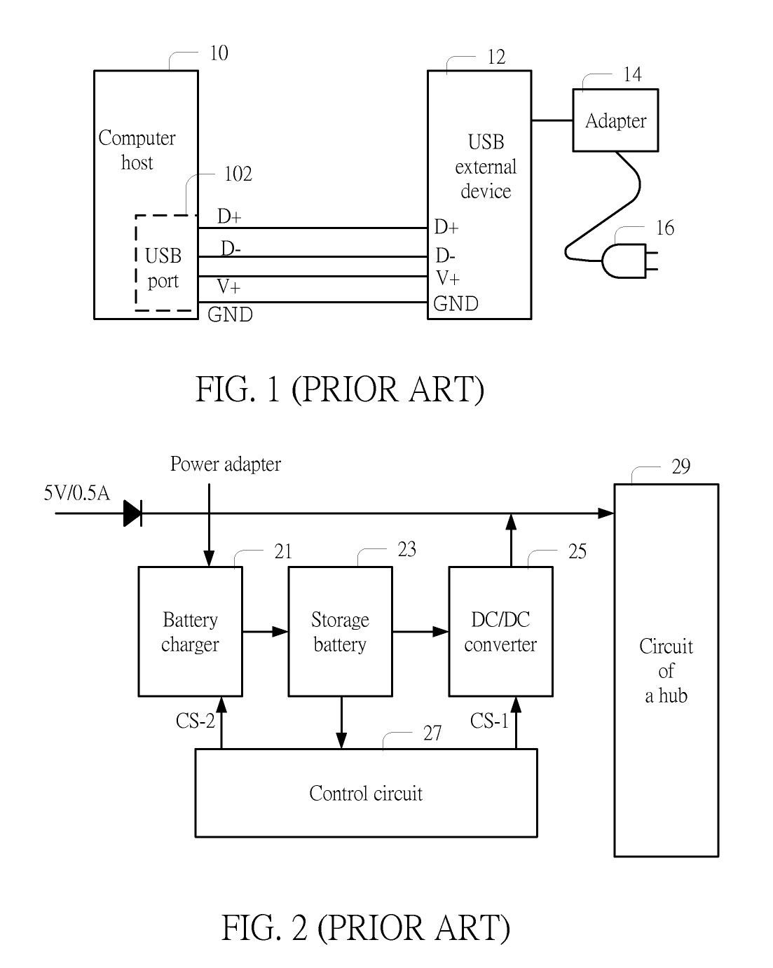

### DETAILED DESCRIPTION OF PREFERRED EMBODIMENTS

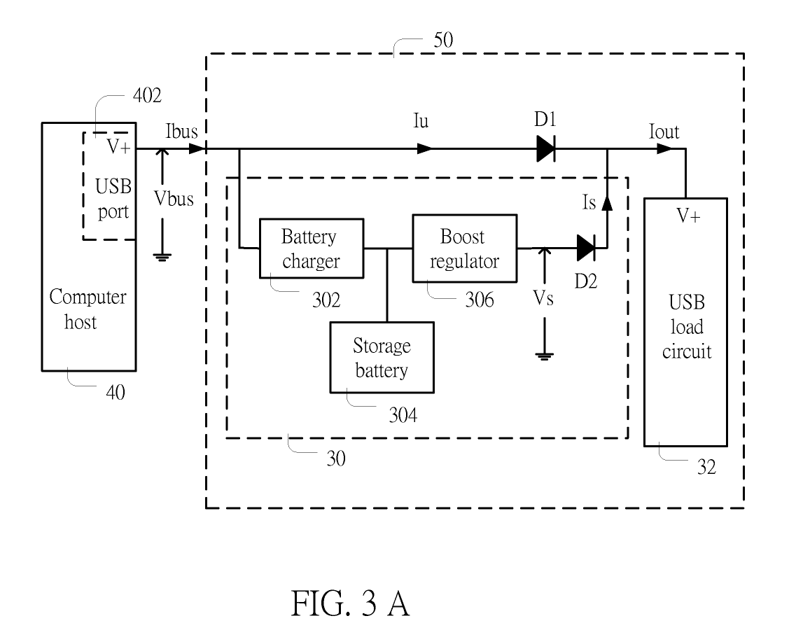

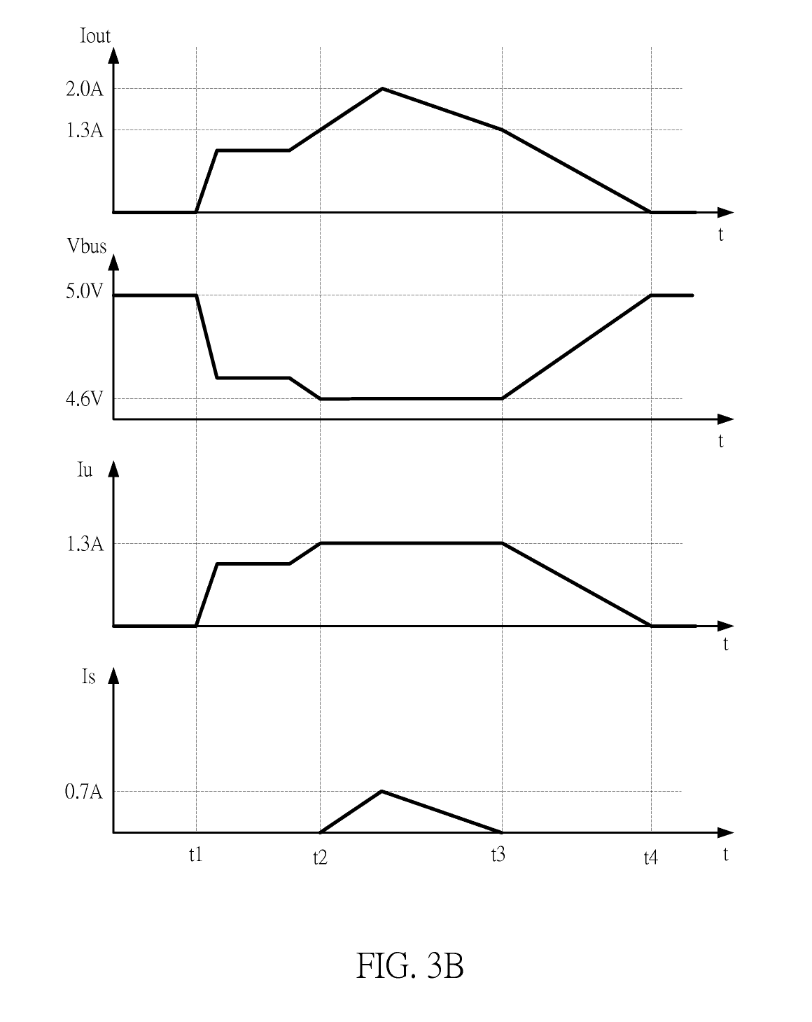

FIG. 3A is a block diagram illustrating an USB external device with an internal assisting power of a first embodiment of the present invention. The USB external device 50 comprises a first ideal diode D1, an assisting power circuit 30, and an USB load circuit 32, where the USB load circuit 32 can be a slim optical disc drive or other high-power-demand devices. The assisting power circuit 30 further comprises a battery charger 302, a storage battery 304, a boost regulator 306, and a second ideal diode D2.

A computer host 40 comprises an USB port 402. The USB port 402 comprises a positive-power terminal (V+) from which an USB-port voltage (Vbus, 5V) and an USB-port current (Ibus, up to 1.3 A) are outputted to the USB external device 50. Moreover, the USB-port voltage (Vbus) is dropped to 4.6V if the USB-port current (Ibus) is up to 1.3 A, and the USB port 402 is forced to shutdown when the USB-port voltage (Vbus) is lower than 4.6V. Moreover, to simplify the introduction of the circuit design of the first embodiment of the present invention, only the positive-power terminal (V+) is shown in FIG. 3A.

As depicted in FIG. 3A, the positive-power terminal (V+) of the USB port 402 is connected to an anode of the first ideal diode (D1). The positive-power terminal (V+) of the USB load circuit 32 is connected to a cathode of the first ideal diode (D1). An input end of the battery charger 302 is connected to the positive-power terminal (V+) of the USB port 402; an output end of the battery charger 302 is connected to the storage battery 304 and an input end of the boost regulator 306. An output end of the boost regulator 306 is connected to an anode of the second ideal diode (D2). A cathode of the second ideal diode (D2) is connected to the positive-power terminal (V+) of the USB load circuit 32.

Moreover, the storage battery 304 can be a lithium battery from which a voltage of 3.7V is outputted.

Moreover, the output voltage from the output end of the boost regulator 306 is named as alarm voltage (Vs), where the value of the alarm voltage (Vs) is set to the alarm value (4.6V) in the first embodiment and the alarm voltage (Vs) is generated by the boost regulator 306 via boosting the 3.7V which is outputted from the storage battery 304.

Moreover, the current demanded of the USB load circuit 32 is named as load current (Iout). The load current (Iout) is combined by a main current (Iu), which is from the USB port 402 and an assisting current (Is), which is from the storage battery 304.

In the first embodiment of the present invention, the load current (Tout) is completely provided by the USB port 402 if the current demanded of the USB load circuit 32 is lower than a first threshold current. The first threshold current can be 1.3 A which is the maximum USB-port current (Ibus, 1.3 A) that the USB port 402 can output. That is, if the load current (Tout) is lower than 1.3 A, accordingly the voltage at the positive-power terminal (V+) of the USB port 402 is maintained higher than the alarm value (4.6V). Because the voltage at the anode of the second ideal diode (D2) is always kept at 4.6V, which is lower than the voltage at the cathode of the second ideal diode (D2), the second ideal diode (D2) is OFF. Because the second ideal diode (D2) is OFF when the current demanded of the USB load circuit 32 is less than 1.3 A, the load current (Tout) is completely provided by the main current (Iu), that is, Iout=Iu. Moreover, a partial of the USB-port current (Ibus) is transmitted to the battery charger 302 and is used for charging the storage battery 304.

On the other hand, the load current (Iout) is provided by both the USB port 402 and the storage battery 304 if the current demanded of the USB load circuit 32 is higher than a second threshold current. The second threshold current may be higher than the first threshold current, for example 1.31 A. However, the first and second threshold currents can be the same, for example maximum current output from the USB port 402. That is, if the load current (Tout) is higher than 1.3 A, accordingly the positive-power terminal (V+) of the USB port 402 is down to the alarm value (4.6V). Because the voltage at the anode of the second ideal diode (D2) is always kept at 4.6V, which is equal to the voltage at the cathode of the second ideal diode (D2), the second ideal diode (D2) is ON. Because the second ideal diode (D2) is ON when the current demanded of the USB load circuit 32 is higher than 1.3 A, the load current (Tout) is provided by both the main current (Iu) and the assisting current (Is), that is, Iout=Iu+Is. Because Iout=Iu+Is, the shortage between the load current (Iout, higher than 1.3 A) and the main current (Iu, 1.3 A) is provided by the assisting current (Is). Because the USB-port current (Ibus) is maintained at 1.3 A, the voltage at the positive-power terminal (V+) of the USB port 402 is maintained at the alarm value (4.6V), so as the shut-down of the USB port 402 can be avoided.

FIG. 3B is a chart illustrating the change of the related voltages and currents in the USB external device with an internal assisting power of the first embodiment of the present invention.

Before time-point t1, the USB external device 50 is not active and the load current (Tout) demanded of the USB load circuit 32 is zero. Therefore, the USB-port voltage (Vbus) outputted from the USB port 402 is kept at 5V; the main current (Iu) is zero; and the assisting current (Is) is zero.

Between time-point t1 to time-point t2, the USB external device 50 is active and the load current (Iout) demanded of the USB load circuit 32 is increased. However, the load current is less than the maximum USB-port current (Thus, 1.3 A) outputted from the USB port 402, the load current (Iout) is completely provided by the main current (Iu). Therefore, the load current (Iout) is equal to the main current (Iu) and the assisting current (Is) is zero.

Between time-point t2 to time-point t3, the load current (Tout) demanded of the USB load circuit 32 is higher than 1.3 A, the assisting current (Is) is introduced to the USB load circuit 32. Therefore, the USB-port voltage (Vbus) outputted from the USB port 402 is maintained at 4.6V. The load current (Iout) is provided by both the main current (Iu) and the assisting current (Is), that is, Iout=Iu+Is; the main current (Iu) is 1.3 A; the assisting current (Is) is the shortage between the load current (Iout) and the main current (Iu).

Between time-point t3 to time-point t4, the load current (Tout) demanded of the USB load circuit 32 is decreased lower than 1.3 A, and the load current (Iout) is completely provided by the main current (Iu) again. Therefore, the USB-port voltage (Vbus) outputted from the USB port 402 is increased from 4.6V to 5V. The load current (Tout) is equal to the main current (Iu), that is, Iout=Iu; and the assisting current (Is) is zero.

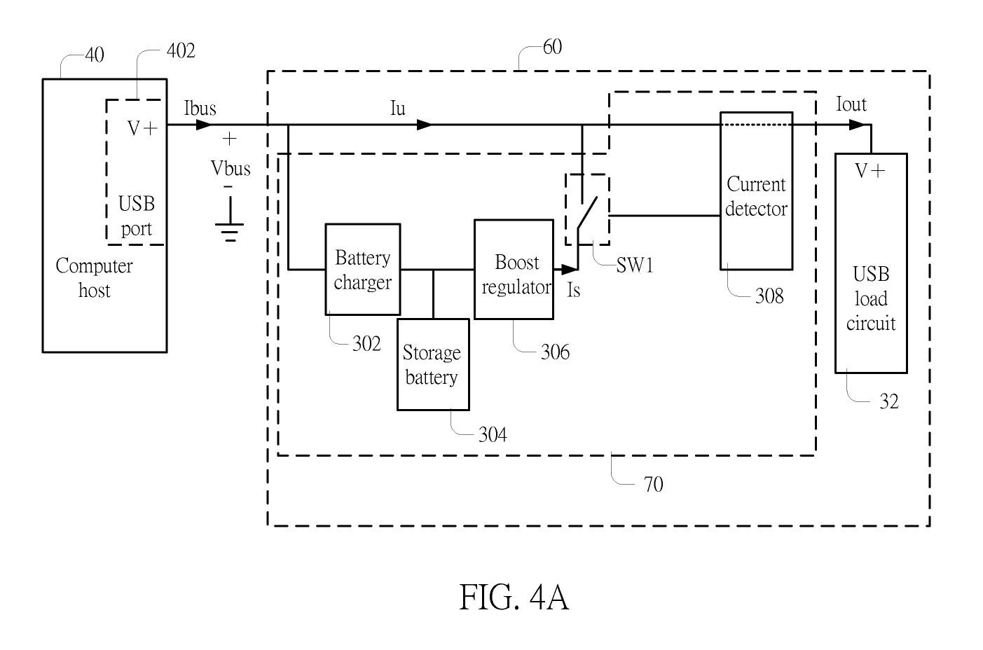

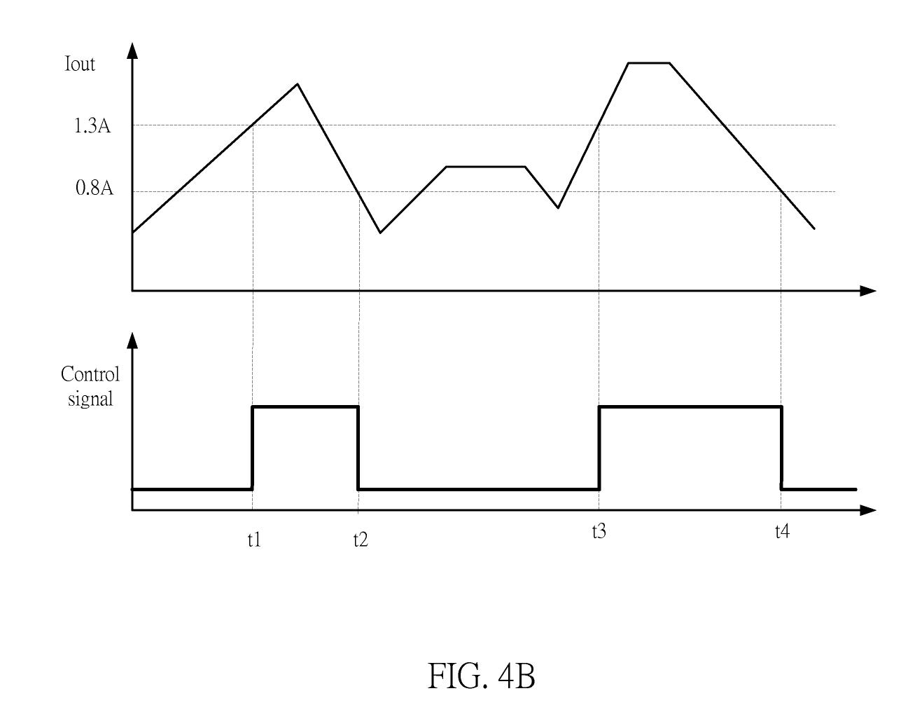

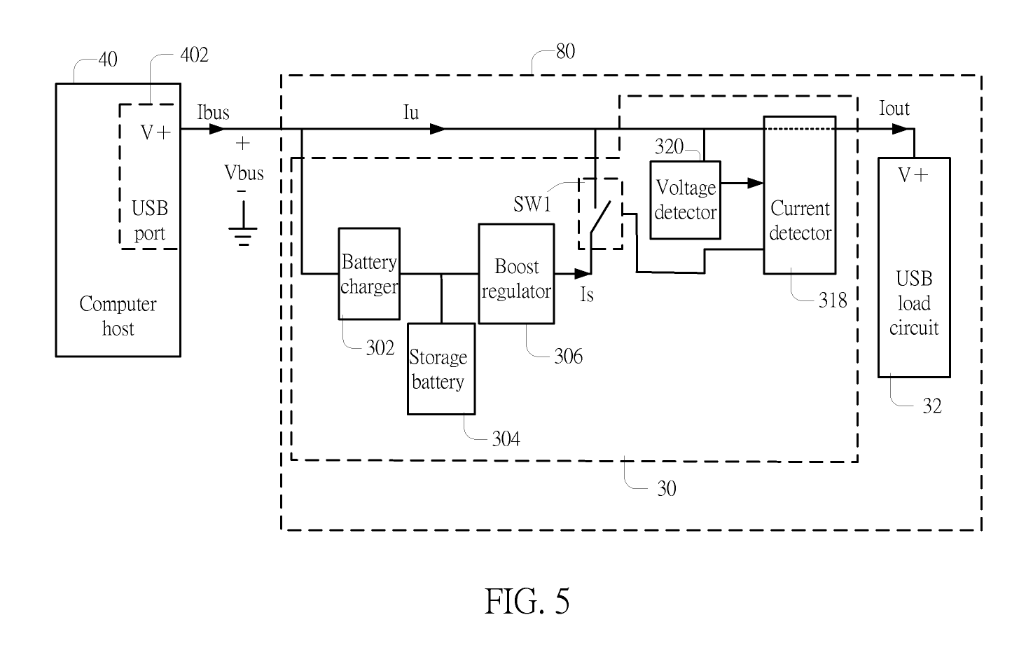

FIG. 4A is a block diagram illustrating an USB external device with an internal assisting power of a second embodiment of the present invention. The USB external device 60 comprises an assisting power circuit 70 and the USB load circuit 32. The assisting power circuit 70 further comprises the battery charger 302, the storage battery 304, the boost regulator 306, a current detector 308, and a switch SW1. The elements with the same numerals denote the same elements as shown in FIG. 3A so some descriptions are omitted herein.

As depicted in FIG. 4A, the positive-power terminal (V+) of the USB port 402 is connected to an input end of the current detector 308; the positive-power terminal (V+) of the USB load circuit 32 is connected to an output end of the current detector 308. An input end of the battery charger 302 is connected to the positive-power terminal (V+) of the USB port 402; an output end of the battery charger 302 is connected to the storage battery 304 and an input end of the boost regulator 306. An output end of the boost regulator 306 is connected to an input end of the switch SW1. An output end of the switch SW1 is connected to the input end of the current detector 308. A control end of the current detector 308 is connected to a control end of the switch SW1. The storage battery 304 is a lithium battery from which a voltage of 3.7V is outputted. The voltage outputted from the storage battery 304 is boosted to 5V by the boost regulator 306.

As described in FIG. 4A, the current demanded of the USB load circuit 32 is named load current (Iout). The load current (Iout) is combined by a main current (Iu), which is from the USB port 402 and an assisting current (Is), which is from the storage battery 304. The load current (Iout) is transmitted from the input end of the current detector 308 and the output end of the current detector 308; where a control signal with a first level (such as a low-level signal) is outputted from the control end of the current detector 308 if the load current (Iout) is detected lower than a first threshold current (0.8 A), and a control signal with a second level (such as a high-level signal) is outputted from the control end of the current detector 308 if the load current (Tout) is detected higher than a second threshold current (1.3 A).

In the second embodiment of the present invention, when the current detector 308 detects load current (Iout) is higher than the second threshold current (1.3 A), the control signal with a high level, for turning-on the switch SW1, is outputted to the control end of the switch SW1 from the output end of the current detector 308. Because the switch SW1 is ON when the current demanded of the USB load circuit 32 is higher than the second threshold current (1.3 A), the assisting current (Is) can be provided to the load current (Tout) via the turn-on switch SW1, that is, Iout=Iu+Is. Because the shortage between the load current (Iout) and the main current (Iu) is provided by the assisting current (Is), the voltage at the positive-power terminal (V+) of the USB port 402 is maintained at the alarm value (4.6V), so as the shut-down of the USB port 402 can be avoided.

On the other hand, when the current detector 308 detects the load current (Tout) is lower than the first threshold current (0.8 A), the control signal with a low level, for turning-off the switch SW1, is outputted to the control end of the switch SW1 from the output end of the current detector 308. Because the switch SW1 is OFF when the current demanded of the USB load circuit 32 is lower than the first threshold current (0.8 A), the load current (Tout) is completely provided by the main current (Iu), that is, Iout=Iu. Moreover, a partial of the USB-port current (Ibus) is transmitted to the battery charger 302 and is used for charging the storage battery 304.

Because the value of the first threshold current (0.8 A) is different with the value of the second threshold current (1.3 A), the switch SW1 will not be frequently ON and OFF if the load current (Iout) is vibrated around at 1.3 A or 0.8 A, so as the more power consumption resulted by the switch SW1 frequently ON and OFF can be avoided. That is, when the switch SW1 is ON due to the load current (Tout) is higher than the second threshold current (1.3 A), the control signal with a low level for turning-off the switch SW1 will not be immediately outputted to the switch SW1 from the current detector 308 if the load current (Tout) is down back to the first threshold current (0.8 A). In other words, the control signal with a low level for turning-off the switch SW1 is only outputted to the switch SW1 from the current detector 308 if the load current (Tout) is lower than the first threshold current (0.8 A). Accordingly, the more power consumption can be avoided if the switch SW1 is frequently ON and OFF when the load current (Iout) is vibrated around at 1.3 A. Similarly, when the switch SW1 is OFF due to the load current (Iout) is lower than the first threshold current (0.8 A), the control signal with a high level for turning-on the switch SW1 will not be immediately outputted to the switch SW1 from the current detector 308 if the load current (Iout) is up back to the first threshold current (0.8 A). In other words, the control signal with a high level for turning-on the switch SW1 is only outputted to the switch SW1 from the current detector 308 if the load current (Tout) is higher than the second threshold current (1.3 A). Accordingly, the more power consumption can be avoided if the switch SW1 is frequently ON and OFF when the load current (Iout) is vibrated around at 0.8 A.

FIG. 4B is a chart illustrating the change of the currents and the control signal in the USB external device with an internal assisting power of the second embodiment of the present invention.

Before time-point t1, the load current (Iout) demanded of the

USB load circuit 32 is lower than the second specific value (1.3 A), a control signal with a low level, for turning-off the switch SW1, is outputted to the control end of the switch SW1 from the output end of the current detector 308. Because the switch SW1 is OFF, the assisting current (Is) cannot be provided to the USB load circuit 32 from the storage battery 304 via the turn-off switch SW1, so as Is=0, Iout=Iu.

At time-point t1, the load current (Tout) demanded of the USB load circuit 32 is higher the second specific value (1.3 A) which is the maximum current provided by the USB port 402, a control signal with a high level, for turning-on the switch SW1, is outputted to the control end of the switch SW1 from the output end of the current detector 308. Because the switch SW1 is ON, the assisting current (Is) is provided to the USB load circuit 32 from the storage battery 304 via the turn-on switch SW1, so as Iout=Iu+Is.

Between time-point t1 to time-point t2, the load current (Tout) demanded of the USB load circuit 32 is always higher than the first specific value (0.8 A), a control signal with a low level, for turning-off the switch SW1, will not outputted to the control end of the switch SW1 from the output end of the current detector 308. Because the switch SW1 is still ON, the assisting current (Is) is provided to the USB load circuit 32 from the storage battery 304 via the turn-on switch SW1, so as Iout=Iu+Is.

At time-point t2, the load current (Tout) demanded of the USB load circuit 32 is lower than the first specific value (0.8 A), a signal with a low level, for turning-off the switch SW1, is outputted to the control end of the switch SW1 from the output end of the current detector 308. Because the switch SW1 is OFF, the assisting current (Is) cannot be provided to the USB load circuit 32 from the storage battery 304 via the turn-off switch SW1, so as Is=0, Iout=Iu.

At time-point t3, the load current (Tout) demanded of the USB load circuit 32 is higher than the second specific value (1.3 A), a signal with a high level, for turning-on the switch SW1, is outputted to the control end of the switch SW1 from the output end of the current detector 308. Because the switch SW1 is ON, the assisting current (Is) is provided to the USB load circuit 32 from the storage battery 304 via the turn-on switch SW1, so as Iout=Iu+Is.

FIG. 5 is a block diagram illustrating an USB external device with an internal assisting power of a third embodiment of the present invention. To avoid the USB port is forced to shut-down when the USB-port voltage (Vbus) is down to the alarm value (4.6V) but the load current (Iout) is still lower than 1.3 A detected by the current detector, both a current detector and a voltage detector are introduced in the third embodiment of the present invention. The USB external device 80 in the third embodiment of the present invention comprises an assisting power circuit 90 and the USB load circuit 32. The assisting power circuit 90 further comprises the battery charger 302, the storage battery 304, the boost regulator 306, a current detector 318, a voltage detector 320, and the switch SW1. The elements with the same numerals denote the same elements as shown in FIG. 4A so some descriptions are omitted herein.

An input end of the current detector 318 is connected to the positive-power terminal (V+) of the USB port 402; an output end of the current detector 318 is connected to the positive-power terminal (V+) of the USB load circuit 32; and a control end of the current detector 318 is connected to the control end of the switch SW1. A detect end of the voltage detector 320 is connected to the positive-power terminal (V+) of the USB port 402; and a control end of the voltage detector 320 is connected to the current detector 318.

As depicted in FIG. 5, the load current (Iout) is transmitted from the input end of the current detector 318 to the output end of the current detector 318; where a control signal with a first level (such as a low-level signal) is outputted from the control end of the current detector 318 if the load current (Iout) is detected lower than the first threshold current (0.8 A), and a control signal with a second level (such as a high-level signal) is outputted from the control end of the current detector 318 if the load current (Iout) is detected higher than the second threshold current (1.3 A).

Moreover, a control signal with a first level (such as a high-level signal) is outputted from the control end of the voltage detector 320 if the voltage at the detect end of the voltage detector 320 is detected down to the alarm value (4.6V), where the control signal with a first level (such as a high-level signal) outputted from the control end of the voltage detector 320 is used for forcing the current detector 318 to output the control signal with a second level (such as a high-level signal) to the switch SW1.

In the third embodiment of the present invention, even a control signal with a second level (such as a low-level signal) is outputted to the current detector 318 from the voltage detector 320 when the voltage at the detect end of the voltage detector 320 is detected higher than the alarm value (4.6V), a control signal with a second level (such as a high-level signal) is still outputted to the control end of the switch SW1 from the control end of the current detector 318 once the load current (Iout) is detected higher than the second threshold current (1.3 A). Because the switch SW1 is ON, the assisting current (Is) can be provided to the USB load circuit 32 from the storage battery 304 via the turn-on switch SW1. Or, even the load current (Iout) is detected still lower than the second threshold current (1.3 A), a second level (such as a high-level signal) is still outputted to the control end of the switch SW1 from the control end of the current detector 318 once the voltage at the detect end of the voltage detector 320 is detected down to the alarm value (4.6 A). Because the switch SW1 is ON, the assisting current (Is) can be provided to the USB load circuit 32 from the storage battery 304 via the turn-on switch SW1.

Moreover, the first level (such as a low-level signal) is outputted to the control end of the switch SW1 from the control end of the current detector 318 only when the load current (Tout) is detected lower than the first threshold current (0.8 A), so as the switch SW1 is OFF.

To sum up, the characteristics of the USB external device of the present invention can be listed as:

First, the assisting current (Is) in the first embodiment can be controlled to the USB load circuit 32 via the second ideal diode (D2), so as the assisting power circuit 30 can be implemented without a complicate design.

Second, because the assisting current (Is) outputted from the storage battery 304 is not responsible for the whole load current (Tout) but is only used for the shortage between the load current (Iout) and the main current (Iu), the storage battery 304 can be implemented by one lithium battery, so as the size of the storage battery 304 is minimized.

Third, because the assisting current (Is) outputted from the storage battery 304 is only used for the shortage between the load current (Tout) and the main current (Iu), the USB-port current (Ibus, 1.3 A) is always provided to the load current (Tout) when the load current (Tout) demanded of the USB load circuit 32 is higher than 1.3 A.

Fourth, because the assisting power circuit is arranged in the USB external device, the power adapter or the hub which can supply power actively is then unnecessary, and it is much convenient to user.

Moreover, it is to be understood that the first ideal diode (D1) and the second ideal diode (D2) arranged in the assisting power circuit 30 of the first embodiment can be replaced by other devices, such as the normal diodes by simple modification.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An universal-serial-bus external device connected to an universal-serial-bus port of a computer host, wherein the universal-serial-bus port comprises a positive-power end from which a main current is outputted, comprising:
a load circuit comprising a positive-power end, wherein a load current, for driving the universal-serial-bus external device, is inputted to the positive-power end of the load circuit; and
an assisting-power circuit comprising an output end from which an assisting current is outputted to the positive-power end of the load circuit;
wherein the load circuit is only provided by the main current if the load current is lower than a first threshold current; and, the load circuit is provided by both the main current and the assisting current if the load current is higher than a second threshold current.

2. The universal-serial-bus external device according to claim 1 wherein the positive-power end of the universal-serial-bus port is connected to an anode of a first diode and the positive-power end of the load circuit is connected to a cathode of the first diode.

3. The universal-serial-bus external device according to claim 2 wherein the output end of the assisting-power circuit is connected to an anode of a second diode and the positive-power end of the load circuit is connected to a cathode of the second diode.

4. The universal-serial-bus external device according to claim 3 wherein the second diode is OFF if the load current is lower than the first threshold current; and, the second diode is ON if the load current is higher than the second threshold current.

5. The universal-serial-bus external device according to claim 1 wherein the assisting-power circuit comprises a storage battery and the storage battery is charged via the positive-power end of the universal-serial-bus port if the load current is lower than the first threshold current.

6. The universal-serial-bus external device according to claim 5 wherein the assisting-power circuit further comprises:
a battery charger comprising an input end connected to the positive-power end of the universal-serial-bus port and an output end connected to the storage battery; and
a boost regulator, connected to the output end of the battery charger, from which the assisting current is outputted to the positive-power end of the load circuit.

7. The universal-serial-bus external device according to claim 5 wherein the storage battery is a lithium battery.

8. The universal-serial-bus external device according to claim 6 wherein the assisting-power circuit further comprises:
a current detector comprising an input end, an output end, and a control end, wherein the load current is flowed from the input end of the current detector to the output end of the current detector;
a switch comprising an input end connected to an output end of the boost regulator, an output end connected to the input end of the current detector, and a control end connected to the control end of the current detector;
wherein the switch is controlled to ON by the current detector if the load current is higher than the second threshold current; and the switch is controlled to OFF by the current detector if the load current is lower than the value of the first threshold current.

9. The universal-serial-bus external device according to claim 8 wherein the assisting-power circuit further comprises:
a voltage detector comprising a detect end and a control end, wherein the detect end is connected to the positive-power end and the control end is connected to the current detector.

10. The universal-serial-bus external device according to claim 9 wherein the voltage detector outputs a control signal with a first level to the current detector when the voltage is lower than an alarm value, and the switch is controlled to ON by the current detector when the load current is lower than the second threshold current.

11. The universal-serial-bus external device according to claim 9 wherein the voltage detector outputs a control signal with a second level to the current detector when the voltage is higher than an alarm value, and the switch is controlled to ON by the current detector when the load current is higher than the second threshold current.

12. The universal-serial-bus external device according to claim 1 wherein the value of the first threshold current is equal to the value of a maximum-output current from the universal-serial-bus port.

13. The universal-serial-bus external device according to claim 12 wherein the first threshold current is the same as the second threshold current.

14. The universal-serial-bus external device according to claim 1 wherein the first threshold current is 0.8 A and the second threshold current is 1.3 A.

15. The universal-serial-bus external device according to claim 1 wherein the assisting current is the difference between the load current and a maximum-output current from the universal-serial-bus port.
